(19) United States
(12) Patent Application Publication
(10) Pub. No.: US 2007/0150934 A1
(43) Pub. Date: Jun. 28, 2007

(54) Dynamic Network Identity and Policy management

(75) Inventors: Sergio Fiszman, Nepean (CA); David Price, Reading (GB); Edwin Koehler, Ontario, NY (US)

Correspondence Address: McGUINNESS & MANARAS LLP, 125 NAGOG PARK, ACTON, MA, 01720, US

(73) Assignee: Nortel Networks Ltd.

(21) Appl. No.: 11/425,806

(22) Filed: Jun. 22, 2006

Related U.S. Application Data
(60) Provisional application No. 60/752,988, filed on Dec. 22, 2005.

(51) Int. Cl. H04L 9/00

(52) U.S. Cl. 726/1

(57) ABSTRACT

Network policies are managed based at least in-part on user/entity identity information with: a state monitor operable to monitor for state change events in user/entity state and related, network state or in traffic pattern and traffic flow state; an identity manager operable to obtain and validate user credentials; and a policy manager operable in response to a state change event detected by the state monitor (either the identity manager or a defense center) to select a policy based in-part on the user identity obtained by the identity manager or security context obtained by the defense center, and to prompt application of the selected policy. The policies are indicative of user/device authorization entitlements and restrictions to utilization of certain network resources, network services or applications. Dynamic policy selection and targeted responses can be used, for example, against a user who gains network access with stolen user ID and password, and subsequently attempts malicious behavior. In particular, the malicious behavior is detected and identified, and the malicious user can then be restricted from abusing network resources without adversely affecting other users, groups, network devices, and other network services.

### CROSS-REFERENCE TO RELATED APPLICATIONS

A claim of priority is made to U.S. Provisional Patent Application No. 60/752,988, filed Dec. 22, 2005, entitled DYNAMIC NETWORK IDENTITY AND POLICY MANAGEMENT, which is incorporated by reference. U.S. patent application Ser. No. 11/329,854, filed Jan. 11, 2006, entitled END-TO-END IP SECURITY may also be related, and is incorporated by reference.

### FIELD OF THE INVENTION

This invention relates generally to communications network, and more particularly to employing dynamic network identity management to facilitate policy management, including network threat management.

### BACKGROUND OF THE INVENTION

Network users often have multiple identities (“IDs”). For example, one user may have separate user names and passwords for different devices and different services, e.g., a phone access code, an email account user name and password, and various user names and account passwords for other network services and applications. Even for a particular type of device or service a user may have separate IDs, e.g., a personal email account and a work email account. The existence of multiple Ids and passwords tends to add management complexity, degrade the user experience, and may actually increase exposure to security threats. For example, a user may become frustrated with being unable to memorize many IDs and resort to easily cracked, simple passwords or easily discovered written notes detailing IDs. Gaining access to one ID may lead to exposure of other IDs.

Identity and Access Management (“IAM”) systems are used to mitigate some of the problems associated with having multiple IDs and passwords. IAM systems perform identity management at the application layer. For example, an IAM application can challenge a user for a single-sign-on password, and then synchronize the various other service passwords on behalf of the user. The single-sign-on password is defined by rules meant to increase security, e.g., automatic password expiration, and mandatory use of non-dictionary character strings, special characters, mixed case and other limitations. However, the network may still be compromised by a miscreant who obtains a valid ID and password. It is known that obtaining a valid password can be relatively easy because users themselves are a weak link in terms of maintaining password confidentiality. In particular, some users are inclined to give their password when asked to do so.

### SUMMARY OF THE INVENTION

In accordance with one embodiment of the invention, apparatus operable to manage network policies based at least in-part on identity comprises: a defense center (i.e., that performs event collection, event filtering, event correlation, and event state change notification) that publishes events to the building blocks that subscribe interest on selected event types. An identity manager operable to monitor and track for state change events in user state and network state, obtains and validates the credentials; and a policy manager operable in response to a state change event detected and sent by either the identity manager, or by the defense center, to select a policy based in-part on the user credentials, user/device state, derived user role, and security context obtained by the identity manager, and to prompt application of the selected policy, the policy being indicative of user/entity authorization entitlements and restrictions to utilization of certain network resources or network services.

The invention advantageously provides dynamic policy selection and targeted response. For example, a user that gains network access with stolen user ID and password who subsequently attempts malicious behavior can be detected and identified with information gathered by the identity manager and the defense center. Further, the malicious user can then be restricted from abusing network resources without adversely affecting other users, network devices, and network services.

### BRIEF DESCRIPTION OF THE FIGURES

FIG. 1 illustrates logical network architecture for providing end point compliance, dynamic network identity, network threat management and network policy management.

FIG. 2 illustrates the IdM service in greater detail.

FIG. 3 is an optional call flow diagram illustrating an interaction of the IdM service and an application or network service.

### DETAILED DESCRIPTION

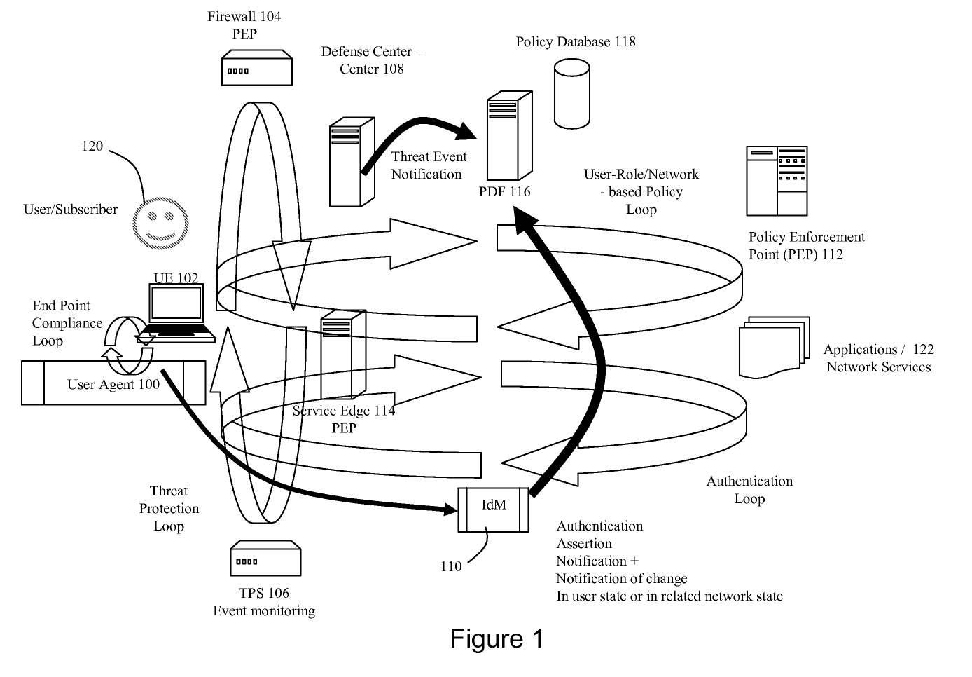

FIG. 1 illustrates logical network architecture for providing dynamic network identity and policy management. The architecture includes a user agent (“UA”) (100) operating on user equipment (“UE”) (102), a firewall (104), a threat protection system (“TPS”) (106) that monitors for specific traffic patterns or flows, a defense center (108), a network identity manager (“IdM”) service (110), at least one policy enforcement point (“PEP”) (112), a network or service edge (“SE”) (114), a policy decision function (“PDF”) (116), and a policy database (118). The user equipment (102) could be a device such as a laptop computer, PDA, mobile phone, sip phone, personal computer, computer terminal, or any other networkable device. The user agent (100) is a software client that is executed by the user equipment. The user agent is operable to challenge the user (120) for logon credentials such as user ID and password. The user agent is also operable to send requests to the SE (114) on behalf of the user. The firewall (104) is operable to prevent unauthorized access to the network, as a policy enforcement point (PEP). The policy database (118) contains a set of predetermined policies that are available to the PDF (116) for distribution to the PEPs. The PDF is operative to select and distribute policies to selected ones of the various PEPs of switches, firewalls, and other network devices. The PEP functionality may be implemented in L2 switches and firewalls to enforce the policies distributed by the PDF. Examples of policies include, but are not limited to, specific configurations for QoS compliance, bandwidth allocation, and restrictions to network resource or network service access. The TPS is operable to monitor for events that match specific traffic patterns or flows and to send specific event types to the defense center for collection, filtering and correlation.

The IdM service (110) is operable to facilitate integration of identity management functions with policy and threat management functions. An exemplary application of network policy to a user (120) attempting access to the network with a UE (102) is as follows. The first step is that the user and the user agent (100) trigger an identity authentication step with the IdM service (110). In the identity authentication step the IdM gathers the credentials of the user and the credentials of the UE. Further, the IdM checks that these credentials correlate with prior authentication vectors stored into the IdM system. The IdM also provides the UE with a per-user credential (or per-user artifact) that is recognizable by the target application (122). The policy enforcement points (“PEPs”) are operative to enforce the set of policies, i.e., rules, distributed to them by the PDF (116). The policies allow or disallow the UE and user access to connections that are provided by the network, and allow or disallow the UE and user access to resources such as applications that are available via the network. The rules in each policy may apply to groups of users, individual users and associated roles/personas. In order to prompt selection and distribution of policies, the IdM provides entity/user credential information, derived user role, user state and related network state, as well as security context to the PDF either in response to a request (from the PDF) or as a notification (to the PDF). In response, the PDF selects appropriate policies from the policy database (118) and distributes the selected policie(s) to the PEP(s). The selected policies are distributed only to those PEPs which apply for this user/entity/UE. The PEPs then load and execute the policies. The user is granted access to the target application by means of the user agent (100), executing on the UE, and the network, if the user's credentials are validated, and if the policies in the PEPs permit access to the application/resource by the UE and user. The identity management service can detect a change in the user state and send an event to the PDF. For example, the user may have failed an IdM request for re-authentication or may have changed locations. The PDF is operative upon receipt of the user state change event to select a new policy from the policy database and distribute that new policy to the corresponding PEPs. In other words, a policy enforcement change is implemented in response to a user state change, and the policy change is targeted to the particular user or group.

In some instances, an event detected change in network state may be indicative of a threat. An exemplary threat response is as follows. The defense center (108), aided by the TPS (106) detects anomalous behavior of a user (120), and identifies the IP address that the UE (102) has been assigned. The defense center (108) signals the PDF (116) about the anomalous behavior on the IP address, and indicates the severity of the threat and type of threat to the PDF. The PDF then queries the IdM ( 110) to find the identity of the user and the assigned IP address to the UE (102), as well as the IP address and physical port that the assigned IP address is connected to. The PDF uses the response from the IdM to determine what policy or policies are an appropriate response to this event threat, based on predetermined rules. The PDF then selects and distributes the selected new policies from the policy database for installation on the PEPs associated with the user/UE. The correlation of the detected change event with the PDF, and IdM management data points establishes a record that correlates the malicious event, the IP data and the correlated user data. This provides a chain of custody for the data which may be useful in subsequent investigations or even legal proceedings.

To summarize, the detection of state changes that enable the dynamic policy enforcement are notified to the policy decision function (or manager) by either the IdM or the Defense Center. A state monitor that collects filters and correlates events can be logically composed by an IdM and a defense center. The IdM monitors, tracks, correlates and notifies changes in the user authentication, user location, user access, user device, and related network access states. The defense center (“DC”) monitors, tracks, collects, and correlates state changes related to network threats.

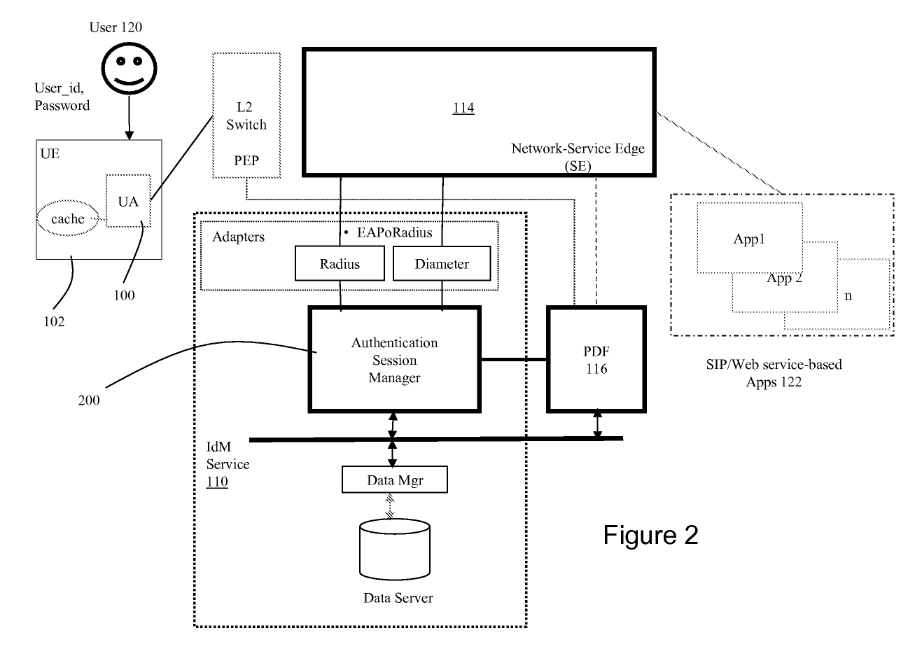

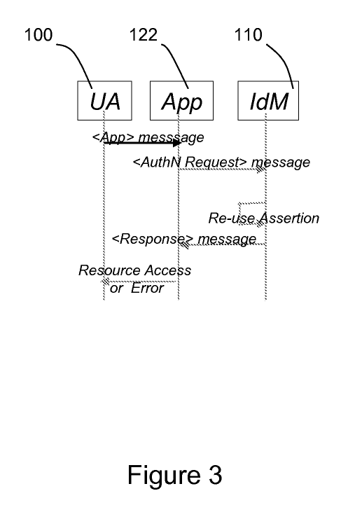

Referring now to both FIGS. 2 and 3, operation of the IdM (110) will be described in greater detail. The IdM performs N-factor authentication and uses correlation of entity (user, device, and group) IDs, network public and private IDs, access media type, authentication procedures, session id, and entity's location. The IdM authentication correlation is functional across access type, device, VPN, SIP, and web services. In the illustrated embodiment the IdM's Authentication Session Manager (“ASM”) also supports authentications and authorization for multiple network access types, e.g., WLAN, wireless, wireline, cable, WiMaX, etc. The IdM may also preserve the security context under roaming and mobility conditions across private and public networks. The IdM is operative to provide single-sign-on and reduced-sign-on (“SSO/RSO”) functionality for network access, session initiation protocol (“SIP”) support, and web-services-based application support. The hub of the IdM system is the Authentication Session Manager (“ASM”) (200). The ASM tracks the user state and the associated network state. The ASM is a rule-based transaction/event system. The data access API used in the IdM is meta-data driven. Further, the IdM enables both dynamic and static network policy management. Static policies are updated due to a calendar event (for example: first day of each month) or a network administrative event (for example: installation of new equipment capacity) and are applied to the PEP associated with entity/user/role-network service relationship as part of a provisioning process. Dynamic policies are updated due to a behavioral and temporal state change event that occurs in the network and are applied to the PEP associated with the entity/user/role-network service relationship, e.g., a user starts a denial of service attack.

The steps of an exemplary RSO call flow will now be described. In the case of a user login, the user establishes communication between the UE and L2 switch. The UE is then assigned a temporary IP address from DHCP, and the UE is put on a guest (i.e., restrictive) VLAN. The L2 switch then sends the following to the network/service edge (“SE”): a) the temporary IP address, b) the L2 switch address and c) the physical switch port. The UA checks/scans the UE for end point compliance, and if the device has met end-point compliance, then the UA prompts the user for its ID, domain, password, and (optional) role. The user responds to the UA's challenge with credentials and the UA requests the backend IdM service, through the SE, to authenticate the user. The IdM (“ASM”) then queries the data manager (“DM”) for the given user ID & password. If the user ID and password are found, the ASM creates a (SAML) assertion token. The ASM then notifies the PDF of the successful authentication, with parameters such as user ID, role, and other dynamic attributes, e.g., location, user access type. The PDF loads the corresponding policies from the data server (“DS”), through the DM interface, and sends the policies to the corresponding PEPs for policy enforcement. The ASM responds successfully to the SE. The SE interacts with DHCP to assign another IP address to the UE, and moves the UE into a “Green” VLAN. The ASM sends an encrypted artifact to the UA, through SE, to the UE. The artifact includes, as a minimum, the address of the ASM and an authentication session ID. The UA then caches the artifact, and acknowledges the user that he/she has been successfully authenticated.

In the case where the user wants to access an application, service or other resource (an application in the illustrated example), the UA wraps the SAML artifact in the headers of a SOAP message with the user request, and sends it to the application. The application issues an <AuthnRequest> message to the IdM (ASM). The IdM (ASM) may re-use the assertion token to get the credentials and security context required by the application. Having received the response from the IdM service, the application can respond to the User's UA request.

Examples of predetermined rules for policy selection based on contextual information from integration of identity management and threat management include the following:

Event: denial of service attack

IdM partial context: source is employee

Response: put employee on separate VLAN; alert IT department

Event: port scanning

IdM partial context: employee has an administrator role

Response: OK; do nothing

Event: access to confidential files, e.g., human resources' records

IdM partial context: employee, not a member of the human resources department

Response: deny access; alert IT department

While the invention is described through the above exemplary embodiments, it will be understood by those of ordinary skill in the art that modification to and variation of the illustrated embodiments may be made without departing from the inventive concepts herein disclosed. Moreover, while the illustrated embodiments are described in connection with various illustrative structures, one skilled in the art will recognize that the invention may be embodied using a variety of specific structures. Accordingly, the invention should not be viewed as limited except by the scope and spirit of the appended claims.

What is claimed is:

1. Apparatus operable to manage network policies based at least in-part on identity comprising:
an authentication session manager operable to monitor for state change events in user state and related network state, and obtain and validate user credentials; and
a policy manager operable in response to a state change event detected by the authentication session manager to select a policy based in-part on the user identity and related network information and security context obtained by the identity manager, and to prompt application of the selected policy, the policy being indicative of authorization entitlements and restrictions to utilization of certain network resources,
whereby the policy is dynamically selected and enforced.

2. The apparatus of claim 1 wherein the policy manager is further operative to select the corresponding policy and to distribute it to at least one policy enforcement point in the network.

3. The apparatus of claim 1 wherein the defense center is operable in response to detection of a state change event to notify the policy manager, and in response the policy manager (i.e., policy decision function) queries the identity manager for user identity information and security context associated with the event.

4. The apparatus of claim 1 wherein the state change event is indicative of a threat.

5. The apparatus of claim 4 wherein the selected policy is a threat response.

6. The apparatus of claim 1 wherein the state change event is indicative of a change in network resource availability.

7. The apparatus of claim 1 wherein the state change event is indicative of a change in network resource need.

8. A method for managing network policies based at least in-part on identity context, comprising the steps of:
monitoring for state change events in user state and related network state with an identity manager's authentication session manager;
obtaining and validating user credentials with the authentication session manager;
in response to a state change event detected by the identity manager, notifying, a policy manager, and prompting application of the corresponding policy, the policy being indicative of authorization entitlement and restrictions to utilization of certain network resources or network services,
whereby the policy is dynamically selected and targeted for the network resource/network service/application.

9. The method of claim 8 including the further step of distributing the selected policy to at least one policy enforcement point in the network.

10. The method of claim 9 wherein the state change event is indicative of a threat.

11. The method of claim 9 wherein the selected policy is a threat response.

12. The method of claim 8 wherein the state change event is indicative of a change in network resource availability.

13. The method of claim 8 wherein the state change event is indicative of a change in network resource need.

14. A method for managing network policies based at least in-part on state change context, comprising the steps of:
monitoring for state change events traffic patterns and flows and related network state with either a defense center and threat protection systems/sensors or an environment state change monitor;
notifying with state context to a policy manager, and prompting application of the corresponding policy, the policy being indicative of authorization entitlement and restrictions to utilization of certain network resources or network services,
whereby the policy is dynamically selected and targeted for the network resource/network service/application.
